(19) United States
(12) Patent Application Publication
(10) Pub. No.: US 2008/0309156 A1
(43) Pub. Date: Dec. 18, 2008

(54) BRAKE CONTROL SYSTEM AND METHOD

(75) Inventor: William R. Kissel, Ortonville, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: KDS CONTROLS, Troy, MI (US)

(21) Appl. No.: 11/854,082

(22) Filed: Sep. 12, 2007

Related U.S. Application Data
(60) Provisional application No. 60/944,204, filed on Jun. 15, 2007.
(60) Provisional application No. 60/947,699, filed on Jul. 3, 2007.

(51) Int. Cl. B60T 13/74; G06F 19/00

(52) U.S. Cl. 303/20; 701/70

(57) ABSTRACT

A system and method establishes an acceleration of a vehicle which may be used to control a brake system of a towed vehicle towed by a towing vehicle. The system and method establish a gravity vector representing acceleration due to gravity, measure acceleration of the vehicle in a first direction and responsively establish a first acceleration value, measure acceleration of the vehicle in a second direction and responsively establish a second acceleration value, and establish a magnitude of the acceleration of the vehicle in a plane orthogonal to the gravity vector as a function of the gravity vector and the first and second acceleration values.

### CROSS REFERENCE TO RELATED APPLICATIONS

The present application claims priority to U.S. Provisional Patent Application Ser. Nos. 60/944,204, filed Jun. 15, 2007 (Attorney Docket No. 071033-00028) and 60/947,699, filed Jul. 3, 2007 (Attorney Docket No. 071033-00029), all of which are hereby incorporated by reference.

### FIELD OF THE INVENTION

The present invention relates generally to brakes, and more particularly, to a brake control system and method for actuating the brakes of a towed vehicle.

### BACKGROUND OF THE INVENTION

Trailer braking systems typically include a towing vehicle and towed vehicle. Application of the brakes of the towing vehicle generally occurs through operator actuation of a brake pedal. It is usually desirable to apply the brakes of the towed vehicle in roughly the same proportion as the brakes of the towing vehicle are applied. Thus, the more forcefully the brakes of the towing vehicle are applied, the more forcefully those of the towed vehicle should be applied.

Where the brakes of the towed vehicle are electrically operated, the performance of the system may suffer from the lack of a readily available electrical signal or data indicating the braking force applied by the brakes of the towing vehicle.

One type of system avoids the need for quantitative braking information by applying the towed vehicle brakes in a steadily increasing manner, up to a maximum value, each time the brakes of the towing vehicle are applied. However, this type of system requires proper calibration on the vehicle and skilled operation by the driver of the towing vehicle. Furthermore, the heavier the trailer, the more desirable it becomes to have the application of the trailer brakes be closely related to the application of the brakes of the towing vehicle.

Other systems utilize one or more sensors which are used to measure the application force applied by the brakes of the towing vehicle. However, these types of systems are costly, due to the cost of the sensors, and require modification of the towing vehicle's safety critical braking system.

Another solution utilizes an accelerometer, such as a mercury switch, pendulum, or other acceleration sensitive mechanical device within the towing vehicle controller, to indirectly measure the brake application force by measuring or responding to the apparent deceleration of the towing vehicle. One such system is disclosed U.S. Pat. No. 6,445,993 issued to Larry Eccleston on Sep. 3, 2002, as indication of the braking of the towing vehicle. The Eccleston system uses an accelerometer mounted directly to a printed circuit board. The PC board is mounted in a device which is mounted within the cab of the towing vehicle. Mounting of the device is restricted to a prescribed range of angular positions. Not only does the device fail to function outside of that range, its operation degrades at a steadily increasing rate as its position departs from the center of that range, i.e., it becomes less and less sensitive to decelerations and more and more sensitive to bumps in the road.

In some acceleration-based trailer braking systems, the value of acceleration associated with a steady vehicle velocity is needed for use as a base value or Zero G Reference. The relationship between the real-time acceleration during braking and this Zero G Reference is used to calculate the desired trailer braking force. The accuracy of this base value determines how smoothly and responsively the trailer brakes engage. To determine this Zero G Reference, the brake controller must sample its accelerometer when there is neither acceleration of the tow vehicle from the engine, nor deceleration from the brakes.

However, the subject trailer braking systems are generally “add-on” accessories which must be universally applicable to a wide variety of host vehicles employing internal sub-systems with vastly different connector and wiring implementations as well as functional architectures. At the present time, there is no practical way of extracting much in the way of system information from the host vehicle for use by an after-market Trailer Brake Controller.

The one piece of vehicle system information that is available is the Stop Lamp or Brake Switch signal. This signal tells the controller whether or not the brake pedal is being applied and nothing else. It does not tell the controller whether the throttle is closed or wide open. It doesn't even tell the controller whether the vehicle is moving.

The Zero G Reference value, therefore, must come from the brake controller's internal accelerometer and a minimal bit of host vehicle system information, the state of the Brake Switch. The quality of the algorithm producing this value has a significant impact on braking performance.

The simplest way to acquire the Zero G Reference is a single sampling of the accelerometer output at the time that the Brake Switch signal indicates pedal pressure. It should be noted that this sampling always occurs before actual physical application of the brakes, which occurs at least a tenth of a second after activation of this switch.

This method assumes that the application of the throttle pedal ceases by the time the brake pedal is pressed. This is usually true for “one-footed” drivers, but there are exceptions. More importantly, this method suffers from its extreme vulnerability to road surface effects like bumps, chuckholes, and especially “washboard” surfaces. Any severe road disturbance at the instant the sample is taken may cause a large error in the Zero G Reference used to calculate braking force in the subsequent braking event.

A somewhat better approach is to pass the accelerometer signal through a low-pass filter and to sample the output of the filter at the time that the brakes are applied. This method effectively uses a time-weighted average of the several seconds of acceleration history just before the brakes are applied as a Zero G Reference. The low pass filter effectively removes most road irregularity transients. On the other hand, it provides more time for a recent throttle-application event to contaminate the value. For example, if a driver is applying heavy throttle, then sees a problem and suddenly applies the brakes, the Zero G Reference is erroneously a reflection of the heavy throttle acceleration. No “coasting” period contributed to the Reference.

Some drag forces can also cause large errors in the Zero G Reference with a much higher regularity. For years, professional drivers have slowed their vehicles by downshifting manual transmissions, generating “engine braking”, and avoiding wear of the friction brakes. New automatic transmissions have control systems which do the same thing without relying on driver skill. More and more large rigs often have a variety of “engine braking” known as “exhaust braking” which generates even more drag by restricting the engine exhaust. These practices and instrumentalities systematically can generate large errors in the Zero G Reference.

The present invention is aimed at one or more of the problems set forth above.

### SUMMARY OF THE INVENTION

In a first aspect of the present invention, a method for controlling the brakes of a towed vehicle, towed by a towing vehicle, in response to actuation of the brakes of the towing vehicle, is provided. The method includes the steps of establishing a reference gravity vector representing acceleration of the towed vehicle and/or the towing vehicle due to gravity, detecting a braking event of the towing vehicle and responsively validating a measured acceleration of the towed vehicle and/or the towing vehicle in first and second directions as a function of the reference gravity vector, and establishing an effective gravity vector as a function of the measured acceleration of the towed vehicle and/or the towing vehicle in the first and second directions if validated and as a function of surrogate data if not validated. The method further includes the step of controlling the brakes of the towed vehicle as a function of the effective gravity vector and measured acceleration of the towed vehicle and/or the towing vehicle in the first and second directions after actuation of the brakes of the towing vehicle.

In a second aspect of the present invention, a method for controlling the brakes of a towed vehicle, towed by a towing vehicle, in response to actuation of the brakes of the towing vehicle, is provided. The method includes the steps of establishing a reference gravity vector representing acceleration of the towed vehicle and/or the towing vehicle due to gravity and detecting a braking event and responsively establishing an effective gravity vector. The effective gravity vector is (a) equal to a surrogate gravity vector if (i) the time period between the current braking event and a previous braking event is less than a predetermined time period and/or (ii) a measured acceleration of the towed vehicle and/or towing vehicle is outside a limited range of the reference gravity vector; or (b) equal to the measured acceleration of the towed vehicle and/or towing vehicle, otherwise. The method further includes the step of controlling the brakes of the towed vehicle as a function of the effective gravity vector and measured acceleration of the towed vehicle and/or the towing vehicle.

In a third aspect of the present invention, a system for controlling a brake mechanism of a towed vehicle towed by a towing vehicle is provided. The system includes an accelerometer device and a controller. The accelerometer device measures acceleration of one of the vehicles in a first direction and responsively establishing a first acceleration value and measures acceleration of the one of the vehicles in a second direction and responsively establishing a second acceleration value, the first and second directions being perpendicular. The controller is coupled to the accelerometer device for establishing a reference gravity vector representing acceleration of the towed vehicle and/or the towing vehicle due to gravity, for detecting a braking event of the towing vehicle and responsively validating a measured acceleration of the towed vehicle and/or the towing vehicle in the first and second directions as a function of the reference gravity vector, and for establishing an effective gravity vector as a function of the measured acceleration of the towed vehicle and/or the towing vehicle in the first and second directions if validated and as a function of surrogate data if not validated. The controller further controls the brakes of the towed vehicle as a function of the effective gravity vector and the measured acceleration of the towed vehicle and/or the towing vehicle in the first and second directions after detection of the braking event.

In a fourth aspect of the present invention, a system for controlling the brakes of a towed vehicle, towed by a towing vehicle, in response to actuation of the brakes of the towing vehicle, is provided. The system includes an accelerometer device and a controller. The accelerometer device measures acceleration of one of the vehicles in a first direction and responsively establishes a first acceleration value. The accelerometer also measures acceleration of the one of the vehicles in a second direction and responsively establishes a second acceleration value. The first and second directions are perpendicular. The controller is coupled to the accelerometer device for detecting a braking event of the towing vehicle and establishing an effective gravity vector. The controller also controls the brakes of the towed vehicle as a function of the effective gravity vector and the measured acceleration of the towed vehicle and/or the towing vehicle in the first and second directions after actuation of the brakes of the towing vehicle. The effective gravity vector is equal to a surrogate gravity vector if (i) the time period between the current braking event and a previous braking event is less than a predetermined time period and/or (ii) the measured acceleration of the towed vehicle and/or towing vehicle is outside a limited range of the reference gravity vector, or is equal to the measured acceleration of the towed vehicle and/or towing vehicle, otherwise.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram of a braking controller or system for controlling the brakes of a towed vehicle towed by a towing vehicle, according to an embodiment of the present invention;

FIG. 2 is a flow diagram of a method for establishing acceleration of a vehicle, according to an embodiment of the present invention;

FIG. 3 is a flow diagram of a method for controlling the brakes of a towed vehicle towed by a towing vehicle, according to an embodiment of the present invention;

FIG. 4 is a flow diagram of a calibration for an accelerometer device, according to an embodiment of the present invention;

FIG. 5A is a graph illustrating operation of the present invention;

FIG. 5B is a diagrammatic illustration of the calibration routine of FIG. 4;

FIG. 6A is a first flow diagram of a method for establishing an effective gravity vector, according to an embodiment of the present invention;

FIG. 6B is a second flow diagram of a method for establishing an effective gravity vector, according to another embodiment of the present invention;

FIG. 7 is a diagrammatic illustration of the vectors used in determining acceleration of a vehicle as a function of an effective gravity vector, according to an embodiment of the present invention;

FIG. 8 is a flow diagram of a method for establishing instantaneous acceleration of a vehicle and controlling the brakes of a towed vehicle, according to an embodiment of the present invention;

FIG. 9 is an exemplary circuit diagram incorporating a pressure sensitive resistor, according to an aspect of the present invention;

FIG. 10 is an exemplary circuit diagram incorporating a low application force membrane switch, according to an aspect of the present invention;

FIG. 11 is an exemplary circuit diagram incorporating an active pressure sensor, according to an aspect of the present invention;

FIG. 12 is a prior art circuit; and,

FIG. 13 is an exemplary circuit diagram providing protection from breakaway switch faults, according to an embodiment of the present invention.

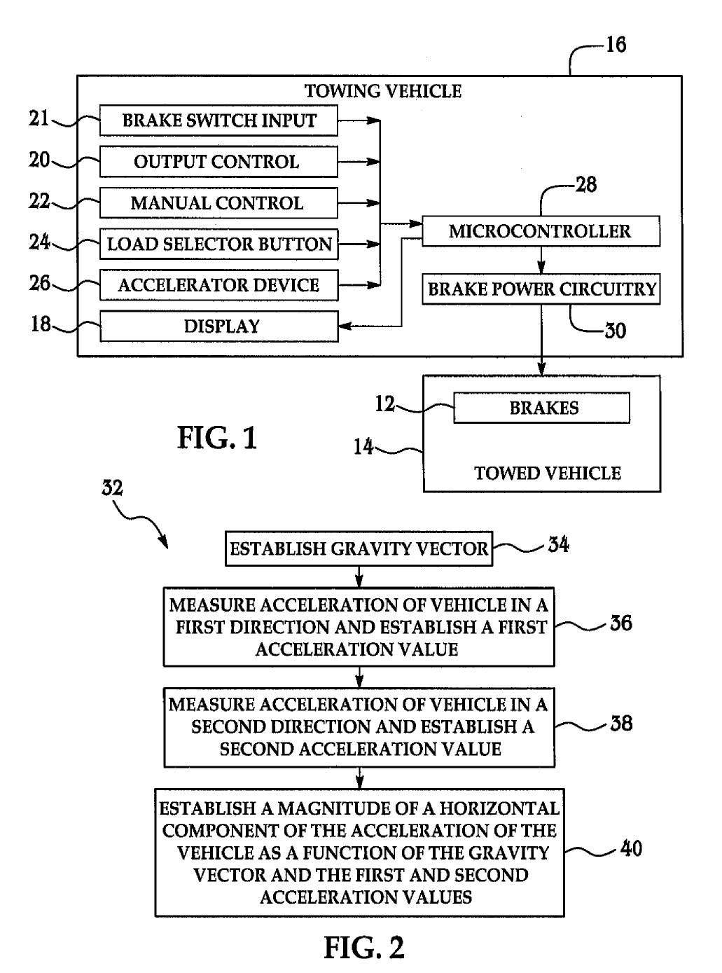

### DETAILED DESCRIPTION OF INVENTION

With reference to the drawings and in operating, the present invention provides a system or brake controller 10 and method for controlling a brake or brakes 12 of a towed vehicle 14 being towed by a towing vehicle 16.

In one aspect of the present invention, the brake controller 10 operates at any mounting angle and responds to longitudinal deceleration of the towing vehicle 16, while ignoring lateral and vertical acceleration (see below). The brake controller 10 operates at any mounting angle about the lateral axis of the towing vehicle 16. For example, it can be mounted under the dashboard of the towing vehicle 16 at around 45 degrees, above the windshield at 45 degrees, vertically to the front of the operator's seat, behind the operator's head (facing opposite the usual direction, or any other location/mounting angle.

In another aspect of the present invention, the brake controller 10 may calculate the horizontal component of braking deceleration without degradation and control the brake(s) of the towed vehicle, accordingly. The horizontal component of the braking acceleration is within an external or world reference frame, i.e. independent of the reference frame of the vehicles. The brake controller 10 will also substantially ignore the vertical component of acceleration, e.g., due to bumps, washboard pavement, etc. . . . , and not let these conditions cause transients or oscillations in the power applied to the brake 12.

Specifically, as described below, the brake controller 10 is located in the towing vehicle 16 and automatically determines the direction in which vehicle deceleration (of the towing vehicle) occurs. Additionally, the brake controller 10 may automatically invert a display 18 to allow for inversion of the brake controller 10 from a normal vertical orientation. The brake controller 10 operates independently of the angle at which the controller 10 is mounted, calculates an instantaneous vehicle acceleration and is relatively immune to acceleration due to the vehicle 16 hitting bumps in the road.

In the illustrated embodiment, the brake controller 10 includes an output control 20, a manual control portion 22, a load selector button 24, an accelerometer device 26, a microcontroller 28, and brake power circuitry 30. The microcontroller 28 receives information from the output control 20, manual control portion 22, the load selector button 24, and the accelerometer device 26 and automatically controls actuation of the brakes 12 of the towed vehicle 14 in accordance with a computer program or software program stored in a memory (not shown).

The output control 20 allows an operator to set a gain parameter for the controller 10. In one aspect of the present invention, the gain parameter is based on the relative size or weight of the towing and/or towing vehicle 14, 16.

The manual control portion 22 allows an operator to manually control operation of the brakes 12 of the towed vehicle 14. Typically, the manual control portion 20 may include a thumb control, such as a potentiometer, which may be actuated by the thumb of the operator. In one embodiment manual control overrides automatic control.

In one aspect of the present invention, the accelerometer device 26 is a two-axis accelerometer having two voltage or pulse width outputs responsive to acceleration in x and y directions. In one embodiment, the accelerometer device 26 is a two-axis device which consists of an integrated circuit that contains both X and Y accelerometer functions. The X and Y directions are perpendicular and lie in the mounting plane of the integrated circuit. The mounting plane may be coplanar with a plane defined by the longitudinal and vertical axes of the towing vehicle 16.

In one aspect of the present invention, the brake controller 10 establishes and maintains a reference gravity vector, G_{ref}, and an effective gravity vector, G. The gravity vectors represent estimates of the acceleration of the device 26 due solely from force of gravity (see below).

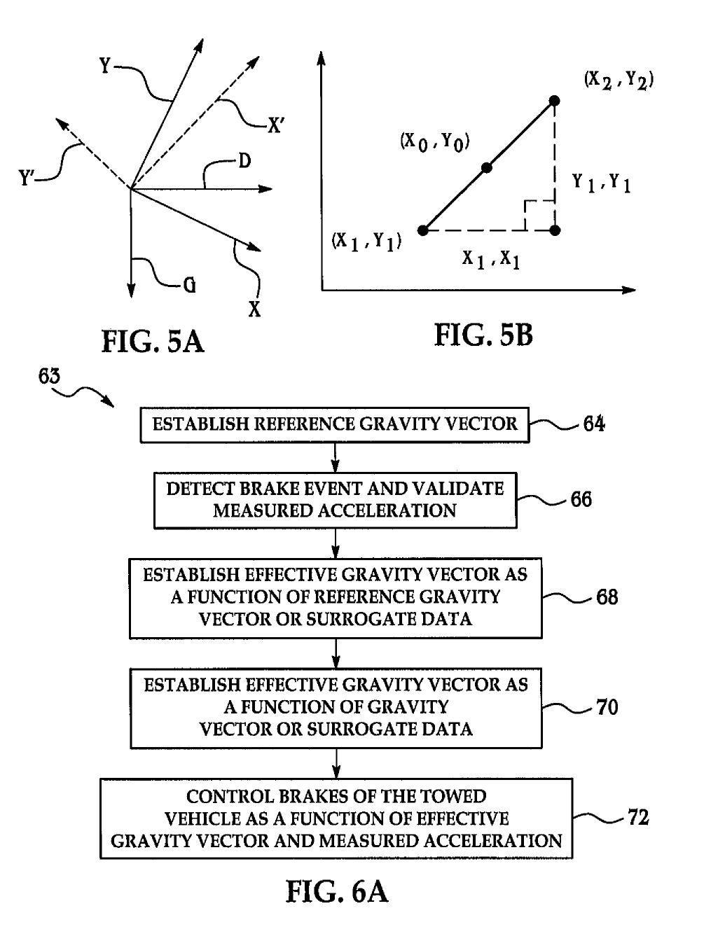

With reference to FIG. 5A, as discussed above, the controller 10 determines the effective gravity vector, G, and the acceleration vector, D, independent of the mounting angle of the controller 10, and thus, the accelerometer device 26. D is in a plane orthogonal to G. The X and Y axis of the accelerometer device 26 may be rotated from D at an angle, θ, at an angle θ′ (as shown in dashed lined) or at any angle.

The microcontroller 28 may implement a software filter with a predetermined time constant, e.g., 128 milliseconds, to reduce the effect of vibrations on the accelerometer device 24.

In one embodiment, the controller 10 drives the brakes 12 of the towed vehicle 14 with a pulse-width modulated (PWM) signal to establish a braking force related to the braking force applied by the brakes of the towing vehicle 16. In one embodiment, the PWM has a frequency of 250 Hz. The duty cycle of the PWM signal determines the braking force.

In the case of manual control, the controller 10 again drives the brakes 12 with a 250 Hz PWM signal. The duty cycle of the PWM signal is determined by the position of the manual control portion 22. The maximum duty cycle of the PWM signal is limited by the maximum setting of output control 20.

In one embodiment, the display 18 includes a two digit LED which displays the duty cycle in percent, resolution one percent, being applied to the brakes 12.

In one embodiment of the present invention, the gravity vector, G, is used to establish an acceleration vector representing the instantaneous acceleration of the towing vehicle 16 due to braking of the towing vehicle 16. This instantaneous acceleration may then be used to control the actuation of the brakes 12 of the towed vehicle 14.

With specific reference to FIG. 2, in one aspect of the present invention a method 32 for establishing an acceleration of a vehicle 16 is provided. In a first step 34, the method 32 establishes an effective gravity vector (G) which represents acceleration due to force of gravity (see below). In a second step 36, the acceleration of the vehicle 16 in a first direction is measured and a first acceleration value is established. In a third step 38, the acceleration of the vehicle 16 in a second direction is measured and a second acceleration value is established. In a fourth step 40, a magnitude of a horizontal component of the acceleration of the vehicle 16 is established as a function of the effective gravity vector and the first and second acceleration values. In one embodiment, the horizontal component of the acceleration of the vehicle 16 is in a plane orthogonal to the effective gravity vector.

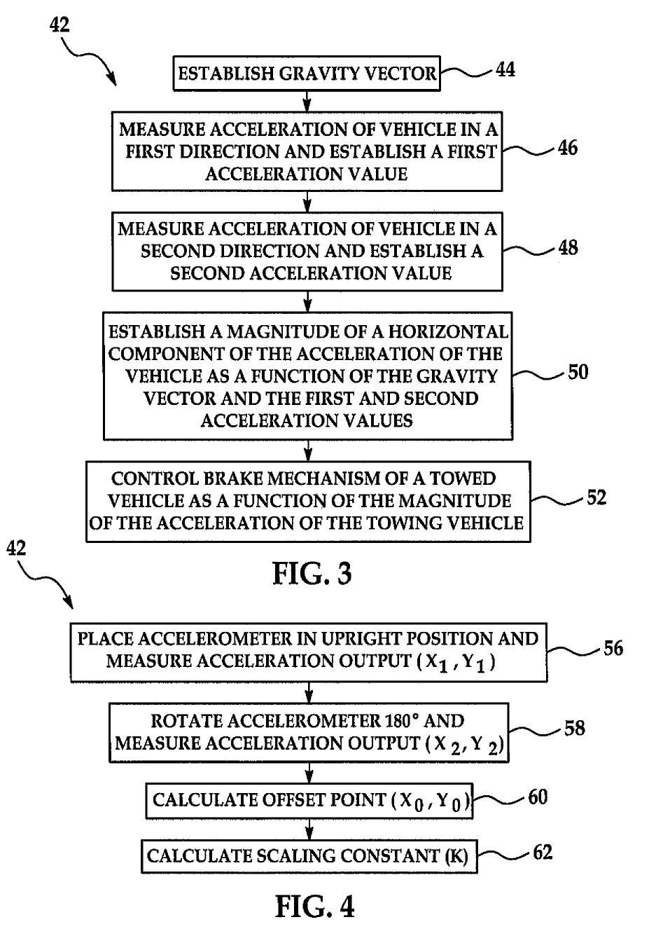

With specific reference to FIG. 3, in one aspect of the present invention a method 42 for controlling a brake or brake mechanism 12 of a towed vehicle 14 towed by a towing vehicle 16 is provided. In a first step 44, the method 26 establishes an effective gravity vector (G) which represents acceleration due to force of gravity.

In a second step 46, the acceleration of the vehicle 16 in a first direction is measured and a first acceleration value is established. In a third step 48, the acceleration of the vehicle 16 in a second direction is measured and a second acceleration value is established. In a fourth step 50, a magnitude of a horizontal component of the acceleration of the vehicle 16 is established as a function of the gravity vector and the first and second acceleration values. In one embodiment, the horizontal component of the acceleration of the vehicle 16 is in a plane orthogonal to the gravity vector. In a fifth step 52, the brake mechanism 12 of the towed vehicle 14 is controlled as a function of the magnitude of the acceleration of the vehicle 16. In one embodiment of the present invention, the brake mechanism 12 is controlled to provide a brake force generally related to the brake force applied by the brakes of the towing vehicle 16.

In one embodiment of the present invention, offsets may be applied to the actual outputs (voltage or pulse width) of the accelerometer device 26 to produce offset-corrected outputs having zero values at zero acceleration. Because of the large variability in the required offsets between accelerometer devices, the offsets may be determined for each accelerometer device (using a calibration routine), which may be run once, during manufacture or at the factory, or periodically. For example, the output of an accelerometer may vary between 0 volts and 5 volts. Ideally, a 2.5 volt output would represent no acceleration, a 0 volt output would represent about −2 G of deceleration, and a +5.0 volt output would represent about +2 G of acceleration. However, due to manufacturing tolerances, a specific accelerometer may exhibit a great deal of voltage variation at no acceleration.

With reference to FIGS. 4 and 5B, a calibration routine 54, according to an embodiment of the present invention is illustrated. The calibration routine 54 takes into account that an accelerometer device will measure the acceleration due to the force of gravity, i.e., 1 G, even when the accelerometer is at rest. In a first step 56, the accelerometer device 24 is placed in an upright position and acceleration in the X and Y directions (X₁, Y₁) is measured (see FIG. 5B). In a second step 58, the accelerometer device 24 is then rotated 180 degrees (in the same plane defined by X and Y) and acceleration in the X and Y directions is again measured (X₂, Y₂,). In a third step 60, an offset point (X₀, Y₀,) is calculated using the following equations:

X₀=(X₁+X₂)/2, and

Y₀=(Y₁+Y₂)/2.

The established offsets, X₀ and Y₀, may be applied to all readings from the accelerometer device 24.

In one embodiment, controller 10 may calculate a scaling factor as a function of the first and second signals read when the accelerometer device 24 is in the first position and the first and second signals read when the accelerometer device 24 is in the second position (in a fourth step 62).

Since the line segment defined by (X₂, Y₂,) and (X₁, Y₁,) is determined at 180 degrees it represents about 2 G's (see FIG. 5B). Thus, a scaling factor, K, may be determined which converts accelerometer output to whatever units are desired. In one embodiment, K may convert the accelerometer output to G units and may be determined by:

K=G²=((X₂−X₁)²+(Y₂−Y₁)²)/4.

As discussed above, in one aspect of the present invention, an effective gravity vector, G, is established which represents the magnitude and direction of vehicle acceleration due to gravity. The gravity vector is independent of how the accelerometer device 24 is mounted in the towing vehicle 16 and defines an external or “world” reference frame. The controller 10 may be mounted at any angle, even upside down, and the gravity vector provides a constant reference. The magnitude of true acceleration of the vehicle 16 may then be determined (see below).

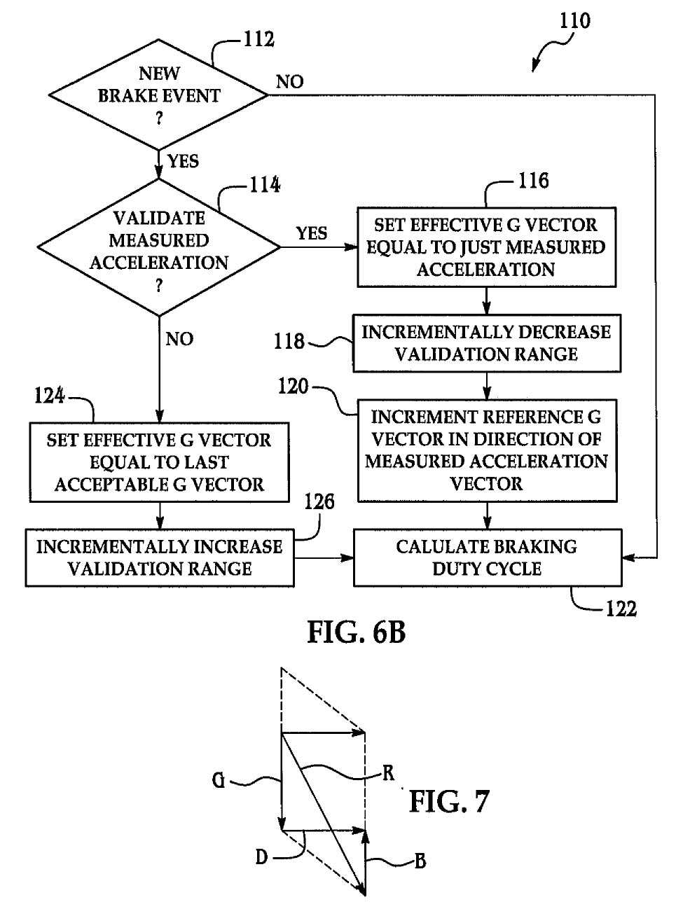

With reference to FIG. 6A, in one aspect of the present invention, a method 63 establishes the effective gravity vector, G which is used in controlling the brakes of the towed vehicle. In a first step 66, the reference gravity vector, G_{ref}, is established (see below). In one aspect, the reference gravity vector represents an estimate of the acceleration of the towed vehicle and/or the towing vehicle 16 due to gravity. In a second step 68, a braking event (see below) is detected and a measured acceleration of the towed vehicle and/or the towing vehicle 16 (or measured acceleration vector) in first and second directions is validated. In one embodiment, the acceleration is measured using a multi-axis accelerometer, e.g., a two or three axis accelerometer. In a third step 70, the effective gravity vector is established as a function of the reference gravity vector or surrogate data.

In one embodiment, the effective gravity vector is established as a function of the measured acceleration vector if the measured acceleration vector is validated and as a function of surrogate data if the measured acceleration vector is not validated. Since the measured acceleration vector at the initiation of the braking event, but before actual application of the brakes, if the measured acceleration vector is validated, it may be utilized as an estimate of the gravity vector, i.e., the effective gravity vector. If the measured acceleration vector at the initiation of the braking event, but before actual application of the brakes, is not validated, then the surrogate data is used as the effective gravity vector (see below).

The brakes of the towed vehicle are controlled, in step 72, as a function of the effective gravity vector and the measured acceleration vector after actuation of the brakes of the towing vehicle 16, as described herein.

In one aspect of the present invention, a braking event of the towing vehicle 16 is sensed through a brake pedal switch (not shown) which senses actuation of the brake pedal (not shown) of the towing vehicle 16. After initiation of the brake event occurs, actual actuation of the brakes of the towing vehicle, i.e., the application of braking force will occur after a delay. However, it should be noted that actuation of the brakes of the towing vehicle 16 may be sensed or established in other ways. For example, actuation of the brakes may be established through pressure sensor(s) (not shown) in the brake system of the towing vehicle 16 or may be established through a signal received from another controller, such as an electronic brake controller (not shown).

In one embodiment of the present invention, the measured acceleration vector utilized is just prior to actual application of the brakes. For example, if the actuation of the brakes is sensed by sensing actuation of a brake pedal, the measured acceleration vector utilized occurs just after brake pedal actuation is sensed, but just prior to actual application of the brakes. In some instances, the time between actuation of the brake pedal and actual application of the brakes may be around one tenth of a second. In one embodiment, the measured acceleration vector is the first measurement of acceleration after actuation of the brake switch (pedal). For example, the measured acceleration vector may be the acceleration reading within the first tenth of a second after actuation of the brake switch (pedal).

Determining the agreement between the measured acceleration vector and the referenced gravity vector may be accomplished by determining the vector cross-product of the reference gravity vector and the measured acceleration vector.

In one aspect, the measured acceleration vector just prior to actual application of the brakes is validated if within a limited range of the reference gravity vector.

In one embodiment, the limited range may be defined by radial degrees. For example, in one embodiment, acceleration is measured using a two axis accelerometer, thus, each acceleration reading provides two acceleration vectors which are at right angles. The two acceleration vectors define a plane. In one embodiment, the measured acceleration vector (defined by the sum of the two acceleration vectors from the two access accelerometer) is validated if within a predetermined angular range, e.g., 4.5° of the reference gravity vector. The tolerance needs to encompass the range of highway grades likely to be encountered. This highest grade found acceptable on US Highways is about 6 degrees, and grades this large are very unusual. The places where grades may be higher than 6 degrees are likely to be residential or non-improved roads or driveways which are too short and where driving speed is too low for deceleration based braking to be significant. The normal angular range for a value of initial acceleration to be found acceptable as a G vector is about 4.5°.

In one aspect of the present invention, the reference gravity vector may be established using a calibration routine and/or an averaging method. In another aspect of the present invention, the reference gravity vector may be established using one or a combination of: (a) a calibration routine which establishes the reference gravity vector while the towing vehicle and/or the towed vehicle are level and stationery, (b) an averaging method which calculates a time weighted and/or event-weighted average acceleration during non-braking conditions, and (c) an averaging method, as described above, but which screens out events likely to be associated with heavy throttle conditions.

In another aspect of the present invention, the conditions for validating the measured acceleration vector just prior to actual application of the brakes become more stringent as a rate of validity increases.

In one embodiment, the surrogate data is the reference gravity vector. In another embodiment the surrogate data is a previous gravity vector, i.e., the effective gravity vector, used in a previous application of the brakes or the reference gravity vector.

In one aspect of the present invention, the measured acceleration vector is not validated, i.e., is not used, if the time period between the current application of the brakes and a previous application of the brakes is less than a predetermined time period. For example, if the time period since a previous application of the brakes is less than 5 seconds, it is reasonably likely that the vehicle had been accelerating from a stop since that time using more than road-load power from the engine. In this case, the historical gravity vector has a higher likelihood of being accurate than a new measurement of acceleration at the beginning of braking.

In another aspect of the present invention, the effective gravity vector is:
(a) equal to a surrogate gravity vector if (i) the time period between the current application of the brakes and a previous application of the brakes is less than a predetermined time period and/or (ii) the measured acceleration vector is outside a limited range of the reference gravity vector; or
(b) equal to the measured acceleration vector, otherwise.

In one embodiment, the offset values and the calculated effective gravity vector, G, are used to determine an instantaneous vehicle acceleration, D. Instant vehicle acceleration (D) is the magnitude of the measured acceleration orthogonal to the gravity vector, G.

With reference to FIG. 6B, in another aspect of the present invention, a method 110 establishes the effective gravity vector, G, which is used in controlling the brakes of the two vehicle. In a first decision block 112, if a braking event (see above) is detected then control proceeds to a second decision block 114, other control proceeds to step 122.

In the second decision block 114, if a measured acceleration vector is validated, than control proceeds to step 116, other control proceeds to step 124. In one embodiment, the measured acceleration is validated if with an acceptable range of degrees from the reference gravity vector.

In step 124, the effective G vector is set to the last acceptable G vector. In step 126, the validation range is decreased. For example, if the measured acceleration vector is not validated, the range of acceptable values may be increased by a predetermined step, e.g., 0.1°, up to and including a predetermined maximum value, e.g., 9.0°.

If the measured acceleration vector is validated, i.e., it is within the acceptable range, then in step 116, the effective G vector is set is equal to the just measured acceleration vector. In step 118, the range of acceptable values may be decreased by a predetermined step, e.g., 0.1°, down to and including a predetermined minimum value, e.g., 4.5°. In a step 120, the reference G vector may be incremented in the direction of the measured acceleration vector by a predetermined step, e.g., 0.1°.

In step 122, the braking duty cycle is calculated as a function of the effective G vector and the measured acceleration vector.

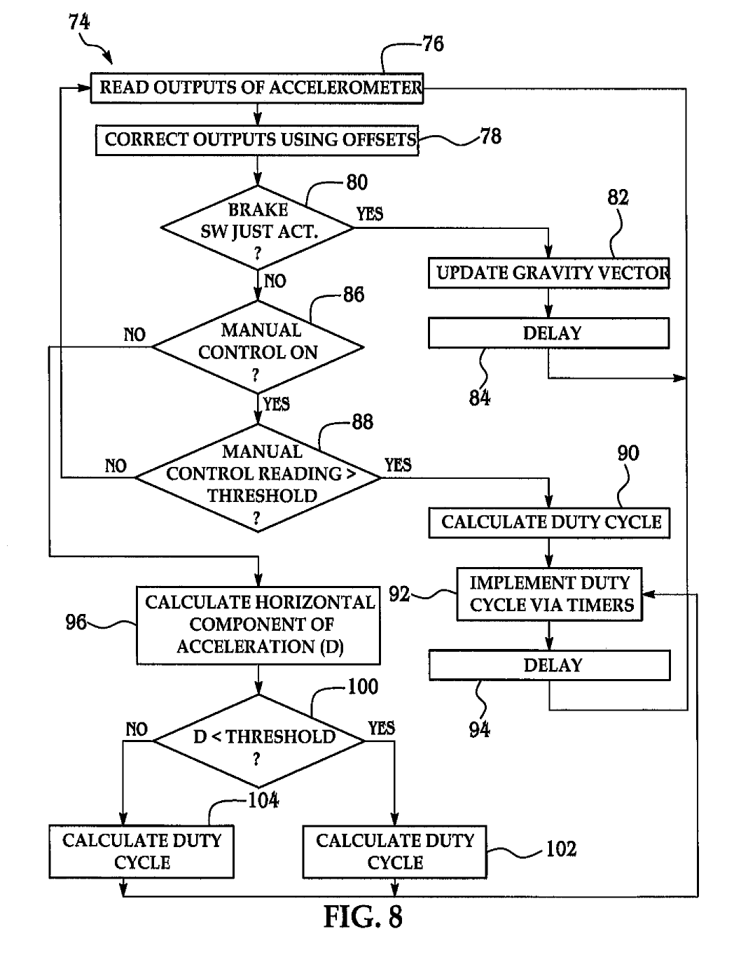

With references to FIGS. 7 and 8, a method 75 for determining instantaneous acceleration of the vehicle 16 is illustrated. In one embodiment of the present invention, the method 74 comprises a loop which is performed once every predetermined loop time. Where appropriate, the method 74 includes a delay to ensure that the loop starts at the next loop time. Although, the term “delay” is used, some functions, such as routine maintenance or diagnostics, may be performed during the “delay”.

In a first step 76, the outputs of the accelerometer 26 are read. The offsets (determined using the calibration routine 54) are applied in a second step 78.

In a first decision block 80, if the brake switch 21 of the towing vehicle 16 has just been activated, then control proceeds to a third step 82. In the third step 82, the gravity vector, G, is updated (see above). In a fourth step 84, a delay is performed.

In the first decision block 80, if the brakes are not off, then control proceeds to a second decision block 86. In the second decision block 86, if the manual control 22 is “on”, indicating operator desires manual control of the brakes 12, then control proceeds to a third decision block 88. In the third decision block 88, if the output of the manual control 22 is over a predetermined threshold, then control proceeds to a fifth step 90. Otherwise the method 74 returns to the first step 76.

In the fifth step 90, a duty cycle of the PWM signal to control the brakes 12 is determined as a function of the gain parameter set by the output control 20 and the manual control 22. In one embodiment of the present invention, the duty cycle of the PWM brake signal is determined using tables stored in memory. A value is returned from the table as a function of the output of the manual control 22. The value is multiplied by the gain parameter to determine the duty cycle. In a sixth step 92, the determined duty cycle is implemented (to control the brakes 12) using a set of software timers. In a seventh step 94, a delay is implemented. Control then returns to the first step 76.

In the second decision block 86, if the manual control is not on, then control proceeds to an eighth step 96.

In the eighth step 96, the magnitude of the horizontal component of the acceleration (D) is calculated (see above).

In fourth decision block 96, if the magnitude of the horizontal component, D, is less than a threshold then control proceeds to a ninth step 102. In one embodiment, the threshold is 0.06 G.

In the ninth step 102, a duty cycle of the PWM signal to control the brakes 12 is determined as a function of output of the output control 20, the setting of the load selector button 24, and the time since the brake event (of the towing vehicle 16). In one embodiment of the present invention, the duty cycle of the PWM brake signal is determined using a second set of tables stored in memory. A value is returned from the table. The value is multiplied by the output of the output control 20 to determine the duty cycle. Control then proceeds to the sixth step 92, during which the determined duty cycle is implemented (to control the brakes 12) using a set of software timers. In the seventh step 94, a delay is implemented. Control then returns to the first step 76.

In the fourth decision block 100, if the magnitude of the horizontal component of the acceleration is not less than the threshold, then control proceeds to a tenth step 104.

In the tenth step 104, a duty cycle of the PWM signal to control the brakes 12 is determined as a function of output of the output control 20, the magnitude of the horizontal component of the acceleration (D), and the setting of the load selector button 24. In one embodiment of the present invention, the duty cycle of the PWM brake signal is determined using a third set of tables stored in memory. A value is returned from the table. The value is multiplied by the output of the output control 20 to determine the duty cycle. Control then proceeds to the sixth step 92, during which the determined duty cycle is implemented (to control the brakes 12) using a set of software timers. In the seventh step 94, a delay is implemented. Control then returns to the first step 76.

With specific reference to FIG. 7, an exemplary illustration of the vectors involved. G represents the gravity vector. R represents the calibrated measured acceleration vector from the accelerometer device 24. D represents the deceleration of the vehicle 16. B represents the vehicle acceleration dues to variations in the road surface, i.e., bumps.

As shown, the magnitude of D may determined as a function of G and R. In one embodiment, the cross product of G and R represents the area of a parallelogram 78 defined by G and the dashed lines. The magnitude of D (D) is calculated by dividing the area of parallelogram 78 by the magnitude of G (which is 1 G). The outputs of the accelerometer device 24 are expressed in arbitrary units, e.g., volts or a pulse width. Thus, the area of parallelogram 78 divided by G is in the same units. Dividing by 1 G again scales the units to G units. Thus, the magnitude of D in G units may be calculated using:

D=|G×R|/(G²)=|G×R|/K.

In another aspect of the present invention, the magnitude of D may be calculated using:

D=|((Y_{D}·X_{G})−(X_{D}·Y_{G})/(G)|, where D is the magnitude of the horizontal component of the acceleration, X_{D} is the measured acceleration in the first direction, Y_{D} is the measured acceleration in the second direction, X_{G} is a first component of the gravity vector, Y_{G} is a second component of the gravity vector, and G is the magnitude of the gravity vector.

To express D in G units, the following may be used:

D=|((Y_{D}·X_{G})−(X_{D}·Y_{G})/(G²)|, where D is the magnitude of the horizontal component of the acceleration, X_{D} is the measured acceleration in the first direction, Y_{D} is the measured acceleration in the second direction, X_{G} is a first component of the gravity vector, Y_{G} is a second component of the gravity vector, and G is the magnitude of the gravity vector.

In another aspect of the present invention, the brake controller 10 may be used to discriminate between braking when the vehicles 14, 16 are going forward or backward. In this aspect, the sign, indicating direction, of D may be used to determine direction.

In one embodiment the controller 10 is turned on or initialized whenever the towing vehicle's stoplamps (brake lights) are actuated, i.e., by application of the brakes of the towing vehicle 16 or activation of the manual control 20. In another aspect of the present invention, the controller 10 includes a method for turning off the brake controller 10 to preserve battery life. The routine only executes when the brakes are applied. The acceleration is periodically sampled. A counter increments each time that the measured acceleration is constant between successive samples. A sample is considered constant if it deviates no more than epsilon from the previous sample. After a total of “Shutdown Limit” successive samples have no deviation, the brake controller 10 is turned off. Additionally, the controller 10 may shut off unconditionally if the brakes are not used after a fixed period of time.

In another aspect of the present invention, a context switching user interface may be provided. Most electronic acceleration-based trailer brake controllers have two functional adjustments: Output and Level. The Output adjustment is essentially the gain of the controller—it is a multiplier applied to the calculated brake activation duty cycle. Its value is reflected in the Maximum Duty Cycle that the controller produces in its Automatic mode (and sometimes in its Manual mode as well).

The Level adjustment, sometimes called Boost, Load, or Range, selects the calibrations appropriate for the tow vehicle and trailer, as well as the preferences of the driver. These calibration curves differ mostly in their aggressiveness—the rate that the trailer brakes are applied as a function of deceleration.

Many customers find that they have several different trailer towing situations that they use repetitively: a horse trailer with horses vs. a horse trailer empty, Ed's preference vs. Charlene's, etc.

Rather than requiring each situation to be set up by adjusting the Output and Level with each change, possibly having to test-drive the vehicle in a parking lot, refer to the manual, etc., it is advantageous to be able to store multiple contexts of Output and Range and to be able to simply select the one being used.

The basic context switching mechanism must be a useful tool and never an impediment to use. It is important that someone oblivious to context switching be able to adjust and use the control without ever having the context switching get in the way.

Calibration:

The calibration function normally needs to be done only once, by the installer of the brake controller. The Level button, in addition to its normal operator function to be described later, serves also as a Calibrate button.

With the vehicle approximately level and its brakes off, the operator presses and holds the Level button. After two seconds, a flashing “CL” appears on the display. If the button is held for another two seconds, the “CL” stops flashing, confirming that calibration has occurred.

If the button is released before confirmation, the controller exits the Calibration Mode without calibrating.

Basic Operation:

When either the + or − buttons are pressed momentarily, the controller goes into an Output Setting Mode, making a “pip” sound and displaying the Output Setting, e.g., a flashing “42”.

The setting may be incremented or decremented by tapping the + or − buttons. If the + or − button is held more than a second, the Output Setting begins to increment, slowly at first and then at an increasing rate, to be able to quickly reach any of the 99 possible values.

At each change, a “pip” sound is made by the controller to provide feedback to the driver without requiring him to look away from the road. Changes take effect immediately as they are entered.

With no button input for two seconds, or any button input other than + or −, the controller exits the Output Setting Mode, making a “pip”.

Similarly, when the Level button is pressed momentarily, the controller goes into a Level Setting Mode, making a “pip” sound and displaying the Level Setting, eg. a flashing “L2”, “E2”, or “H2” depending on whether there are hydraulic brake settings.

Because the Level Setting has a small number of possible values, 4 Electric and perhaps 4 Hydraulic, there is no need for high speed incrementing.

After entering the Level Setting Mode, the Level Setting is incremented cyclically by either tapping the Level button again, or the + button. It is decremented by tapping the − button. Again, with each change there is a “pip” acknowledgement. Changes take effect immediately as they are entered.

With no button input for two seconds, or any button input other than the +, −, or Level buttons, the controller exits the Level Setting Mode.

This basic operation requires no knowledge of context switching and is not handicapped by it. It is intuitive. It is easy to learn and to remember with only the button labels as cues.

Although the operator may or may not be conscious of it, all setting changes are applied to the currently selected context.

Context Switching:

When the User button is momentarily pressed, the controller goes into a User Setting Mode, making a “pip” sound and displaying the User Setting, e.g. a flashing “U2”.

Again, because the User Setting has a small number of possible values, 9 maximum, there is no need for automatic incrementing.

After entering the User Setting Mode, the User Setting is cyclically incremented by either tapping the User button again, or the + button. It is decremented by tapping the − button. Again, with each change there is a “pip” acknowledgement.

With no button input for two seconds, or any button input other than the +, −, or

User buttons, the controller exits the User Setting Mode, making a “pip”.

After any change in User Setting, the old settings are retained, associated with the old User number, and the settings currently associated with the new User number take effect.

The Advanced Mode:

Two possible advanced functions are anticipated that cannot be completely supported by the +, −, User, and Level buttons in an intuitive manner:
An exchange function, exchanging settings between User numbers
An Undo function.

These functions can be implemented without complicating the basic functions, but reference to the User Manual will often be required to use them.

Transferring User Settings to and from the Clipboard and between Users:

The operator first selects the User setting where the Output and Level settings of interest are present. After leaving the User Setting Mode, he presses and holds the + and − buttons simultaneously, holding them for at least three seconds. When both buttons are both released, the display begins flashing a cue, “UC”, for three seconds, confirming to the operator that he now can transfer between User settings and Clipboard. If he presses the +button, settings go from the User context to the Clipboard. If he presses the − button, settings go from the Clipboard to the User settings. In either case, a “pip” and an unflashing “UC” confirm the transfer. Otherwise, the controller simply leaves the Advanced Mode and the flashing “UC” disappears.

By using the Clipboard as an intermediary, settings can be transferred from any User context to any other User context. (It is of course noted that it might be far easier to just write down the settings of the source and dial them into the destination.)

The Undo Function:

If the operator has made changes which were temporary, has accidentally destroyed another operators settings, etc., all settings can be restored to their original values as of the last time the brake controller was powered up.

Again, when the + and − buttons are pressed and held for three seconds and then both released, the display begins flashing a cue, “UC” this time reminding the operator that he can now Undo Changes. If he presses the Level button within three seconds, a “pip” and an unflashing “UC” confirm the Undo. Otherwise, the controller simply leaves the Advanced Mode and the flashing “UC” disappears.

In another aspect of the present invention, improved methods of manual control are provided. Virtually all Electronic Brake Controllers of the type used to control electric or hydraulic trailer brakes have a Manual Control. The requirements of the Manual Control are:

To Power Up the brake controller, should it be in its “sleep mode”, when moved a predetermined distance from its rest stop. (This supplements the usual stimulus for activation, the Brake Switch.)
After the controller is Powered Up, to cause an increasing application of the trailer brakes as it is moved toward its maximum stop.
To cause very little current draw by its circuitry from the battery when at its rest stop. (Brake controllers must draw no more than a milliamp or so in their “sleep mode” in order to not drain the vehicle battery. The Manual Control must be ready to give a Power Up command to the controller while at the same time drawing no more than this amount of current.)

While many older brake controller designs missed the above current draw requirement by an order of magnitude or more, refinements have taken place that allow lever actuated slide or rotary controls using potentiometers or Hall Effect pickups to meet all of these requirements.

However, as brake controllers have become smaller and more feature intense, the amount of surface area taken up by lever operated sliding or rotary controls has become a disadvantage.

To have more of the front panel of its brake controller available for displays and other controls, one manufacturer has located the manual control lever on the bottom of the unit, in the form of a lever which rotates a potentiometer. This has produced objections as to its safety in a collision where any projection could cause injury.

From an ergonomic perspective, a proposed solution to this problem is a pressure activated button which takes up little area and which does not project at all from the controller case. This button may be on the front panel, side, top or bottom of the controller. It may have a tactile feature, such as a depression, so that it can be located by touch without the driver looking down at the control and possibly without the control being readily visible.

This disclosure addresses means to make this proposed solution practical, producing the necessary digital and a linear outputs in response to finger pressures in the 0-1 Pound Force range, over the −40 to 70 Degree C. automotive temperature range, over a long operating life, while drawing an extremely low quiescent current.

In one embodiment, a pressure sensitive resistor (PSR) such as the TekScan FlexiForce A201-1 may be used. This Tekscan PSR device is intended for robotic applications and is fairly expensive. It uses a carefully processed conductive ink pattern between layers of mylar. With no pressure, there is a “breakaway” effect giving the device very low conductance. With a small amount of pressure, the device begins to conduct, and conductance increases linearly with pressure. It is fairly stable with temperature.

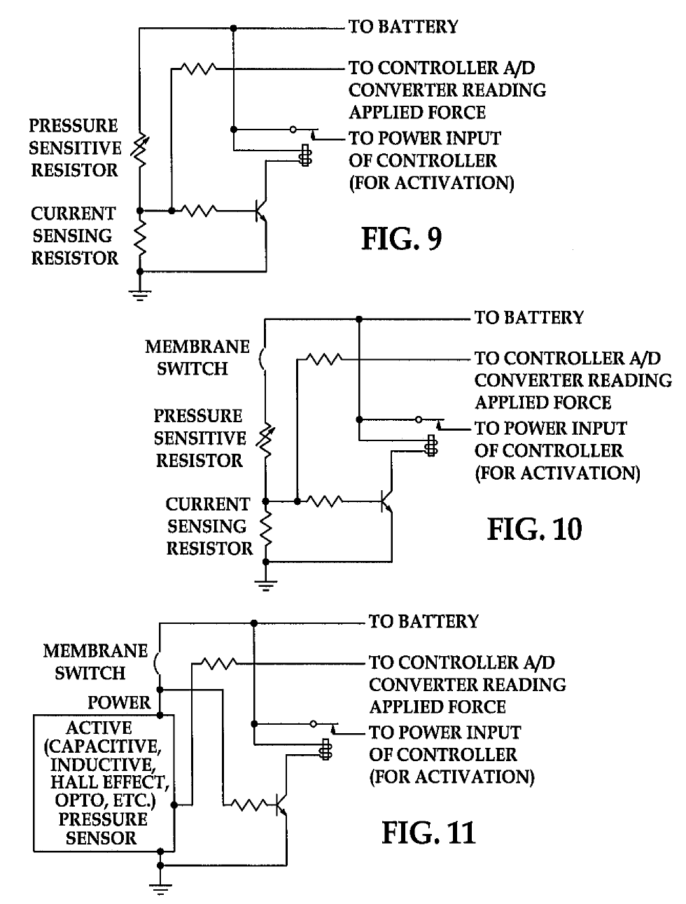

With specific reference to FIG. 9, the PSR is supplied from battery voltage, feeding a current sense resistor, the output voltage of which is applied to the base of a transistor for turning the controller on should it be in “sleep mode”. It is also applied to an A/D converter for measuring the conducted current after Power Up.

Because this PSR device has almost zero conduction with no pressure, with the controller in the “sleep mode” only a miniscule amount of current is drawn. When, due to finger pressure on the PSR button, the conductance increases to the point where the voltage drop across the current sensing resistor reaches the VBE of the transistor, this transistor turns on. Its collector current activates the relay, powering up the controller.

Once Powered Up, the controller applies the trailer brakes with a force determined by the sense resistor voltage, ie. the pressure applied to the button, whenever that voltage is above a predetermined level, and reverts to automatic strategies based on brake pedal application, time, deceleration, etc. otherwise.

Most brake controllers, whether being initially powered up by a Manual Control or by a Brake Switch, are provided with an alternate software-controlled source of power, independent of the mechanism just described, for at least 15 minutes, until “sleep mode” is again appropriate.

In a second embodiment, pressure sensitive resistive material such as Conductive Plastic or Rubber may be used. The pressure sensitive resistor may be fabricated from materials like conductive plastic or rubber for a small fraction of the cost of the premium PSR discussed above. The disadvantage is that these inexpensive PSR's are likely to have large piece-to-piece variation, large temperature variation, and large changes as the material ages.

With reference to FIG. 10, the circuit is similar to the circuit in FIG. 9, except that there is a low-application-force membrane switch physically, as well as electrically, in series with the pressure sensitive resistor coupled to the button. The force applied to the membrane switch and to the PSR are the same. While in “sleep mode”, no pressure applied, no current flows from the battery through this circuit.

In operation, as finger pressure on the button increases, the membrane switch soon closes, commanding the brake controller to Power Up. The controller, during its initialization routine, reads the voltage across the sense resistor and correlates that with the small amount of pressure needed to close the membrane switch. Thereafter, the controller monitors the highest value on the sense resistor with a software “peak detector” as well as the lowest value with a software “negative peak detector”.

In this way, the controller continuously establishes as many as three calibration points which are closely related to the functional requirements of the control. It thereby adapts to unit-to-unit PSR variation, temperature variation, and changes over life.

In a third embodiment, adaptive active sensor technologies may be used.

There are a number of active technologies such as Hall Effect, Capacitive, Inductive, Opto, etc. that could be used in an inexpensive pressure sensor. While they do not display the low current draw and temperature stability necessary to be used in the first embodiment, such technologies may be used in an adaptation of the second embodiment.

With reference to FIG. 11, the circuit is similar to the circuit of FIG. 10 except that a generic active pressure sensor (GAPS) replaces the PSR and sense resistor.

Again, there is a low application force membrane switch physically in series with the pressure port of the sensor—the force applied to the membrane switch and the GAPS are the same.

Regardless of the power requirements of the GAPS, until pressure is applied to the button sufficient to close the membrane switch, no current flows from the battery. When pressure is applied, the membrane switch closes, powering up the GAPS (and possibly the controller.)

Adaptive calibration works similarly to that of the second embodiment. The GAPS is continuously calibrated at switch closure and at maximum pressure, allowing the controller to interpret its output in spite of unit to unit variation, temperature, and life.

In other aspects of the present invention, the brake controller may provide additional features/improvements.

In one aspect a strip manual control may be provided. Such a control would function similarly to a pressure sensitive button except that the input would be a function of where the button was touched, not how hard.

A Spring Loaded Rotary Potentiometer Manual Control Combined with Output Control. When the control was simply turned, it would function as a Manual Control. When it was pushed and turned, it would control the Output Setting.

A finger-tip operated Ledge-Type Manual Control extending over the preponderance of the width of a brake controller across its bottom or top surface or both, the Ledge feature spring-loaded to its rear-most position and movable with the fingers forward of that position, the Ledge feature being coupled to a potentiometer or linear sensor. As an enhancement, a locking brake coupled to this Ledge-Type control, engaged by uneven pressure, and disengaged by even pressure, to cause the Ledge-Type Control to be temporarily held in a position off its normal rest-stop to provide hands-off manual braking.

A Brake Controller separated into User Interface and Controller modules, connected by a wireless link may also be provided. Location of the Controller closer to the hitch, or on the trailer, would provide wiring advantages as well as better Yaw data for stability control. A Flip Door User Interface and Manual Control. Most customers are not interested in a trailer brake controller on a routine basis, other than knowing that it is working. A brake controller, or brake controller user interface head, could be packaged in a low profile package similar to a cell phone. With the Flip Door closed, only a bar graph showing trailer brake application would be visible. Opening the door would reveal other displays and controls. Pushing the door past its natural stopping point could activate the Manual Control function. It goes without saying that the Flip Door would have to be on breakaway hinges so as not to produce injury, but not easily broken so as to need repair.

A Brake Controller including a Vehicle Speed Sensor may be provided. In order to implement trailer stability methods, a vehicle speed sensor would be needed.

In a further aspect of the present invention to activate the trailer brakes in the event of a separation between the towing vehicle and the trailer.

Federal traffic safety regulations, in 49CFR393.43, require that all trailers that are legally required to have brakes also to have a Breakaway Switch. This switch is intended to activate the trailer brakes should the trailer become separated from its tow vehicle.

In electric brake systems, these switches simply connect the trailer brake circuit to a trailer-mounted storage battery. During separation, a pin is pulled out of the trailer-mounted switch by a cable attached to the tow vehicle, activating the switch. The run-away trailer is left behind with its brakes fully applied, connected to its own dedicated battery, reducing the danger of the separation.

Operators and safety inspectors sometimes test the switches by pulling the pin and determining whether the trailer brakes are applied. Unfortunately, the breakaway switches on the market today are potentially destructive to brake controllers because they do not disconnect the trailer brakes from the brake controller as they connect them to the trailer battery.

Therefore, it is common for the instructions for prior art Breakaway Switches to contain a warning to disconnect the trailer plug before testing breakaway unit.

Further, some people are not aware that the Breakaway Switch pin must never be pulled while the trailer connector carrying the brake circuit is connected.

As brake controllers have been integrated into new pickup truck models, they have become subject to specifications written by auto manufacturers aware of the Breakaway Switch induced failure mechanism and requiring that the vulnerable components of the brake controller be disconnected automatically should the pin be pulled with the brake controller connected.

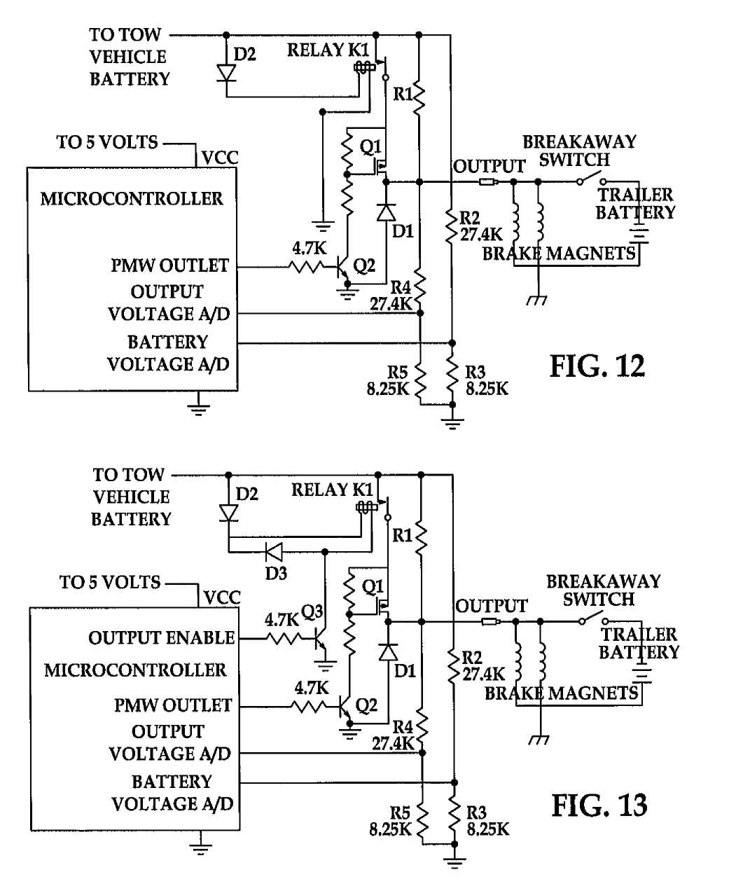

In the prior art brake controller circuitry of FIG. 12, Q1 is a P-Channel Power FET supplying the Brake Magnets with a PWM signal that is generated by the Microcontroller. Q1, as do virtually all P-Channel Power FET'S, contains a parasitic diode. The anode of this diode is the Drain and the cathode is the Source. In normal operation, the diode is back-biased because the Drain is negative with respect to the Source.

If a Breakaway Switch Fault occurs, i.e., the switch is closed while the Trailer Connector is still connected, the Trailer Battery is connected to the Tow Vehicle Battery with only the properties of Q1 limiting the current.

If the Tow Vehicle is started while this connection exists, the Trailer Battery will assist the Tow Vehicle Battery in operating the cranking motor. This “helping” current passing through the parasitic diode—depending on the state of charge of the two batteries—could easily reach 100 amperes and destroy the brake controller.

If the brakes of the tow vehicle are simply applied while the pin is removed, another possibly destructive condition happens. Transistor Q1 will turn on, connecting the Trailer Battery to the Tow Vehicle Battery. Depending on the difference in state-of-charge of the two batteries, the FET drain current could exceed the normal 25 Ampere maximum expected in the application. Particularly if the battery-to-battery current is flowing toward the tow vehicle, short circuit protection mechanisms will not prevent damage to the brake controller.

In FIG. 9, it should be noted that the presence of the following components which have diagnostic and protective functions:
R1, a pull-up resistor which tends to elevate the Output Voltage if no low-impedance trailer brake magnet load (0.5-2.0 Ohms) to ground is present.
R2 and R3, which communicate the Battery Voltage to an A/D converter where it can be measured.
R4 and R5, which communicate the Output Voltage to an A/D converter where it can be measured.
Relay K1, activated through diode D2, connects Q1 to the tow vehicle battery only if the battery voltage is positive.

If the Output Voltage is high even when Q1 is off, the trailer brake magnets are probably disconnected. The microcontroller will warn the operator after this condition first occurs, in case the trailer plug has fallen out, and then shut off its display as operation without a trailer is a normal condition.

If during operation of the trailer brakes, the difference between Battery Voltage and Output Voltage is atypically large during the part of the PWM cycle when Q1 is on, the trailer brake magnet circuit may be drawing excessive current or be in fact shorted to ground. Before this large voltage drop and accompanying dissipation damages Q1, operation will be terminated for a “cool off” interval and then tried again. A diagnostic message indicating a short circuit will be generated.

If the battery of the tow vehicle is installed backwards, Relay K1 protects the brake controller—its contacts do not close unless D2 is forward biased. Otherwise, the parasitic diode within Q1 and similarly polarized diode D1 would be forward biased directly across the reversed battery, destroying the brake controller.

With reference to FIG. 13, Q3 and a few supporting components, as shown, can provide protection from Breakaway Switch Faults by placing Relay K1 under microprocessor control.

The microcontroller regularly polls the Output Voltage of the brake controller and the Battery Voltage during each portion of the PWM cycle. In addition to verifying normal operation, identifying any short circuits and open circuits, the microcontroller software can take the following additional action: if the brake controller output is high during the portion of the cycle when Q1 is off, instead of merely providing a diagnostic message that the trailer may have become disconnected, it can turn Q3 off, opening the contacts of Relay K1, and disconnecting the output circuit from the tow vehicle battery.

If the situation was an open load, opening the relay has no consequence—the output circuit was not driving anything.

Obviously, many modifications and variations of the present invention are possible in light of the above teachings. The invention may be practiced otherwise than as specifically described within the scope of the appended claims.

What is claimed is:

1. A method for controlling the brakes of a towed vehicle, towed by a towing vehicle, in response to actuation of the brakes of the towing vehicle, comprising the steps of:
establishing a reference gravity vector representing acceleration of the towed vehicle and/or the towing vehicle due to gravity;
detecting a braking event of the towing vehicle and responsively validating a measured acceleration of the towed vehicle and/or the towing vehicle in first and second directions as a function of the reference gravity vector, the first and second directions being perpendicular;
establishing an effective gravity vector as a function of the measured acceleration of the towed vehicle and/or the towing vehicle in the first and second directions if validated and as a function of surrogate data if not validated; and,
controlling the brakes of the towed vehicle as a function of the effective gravity vector and measured acceleration of the towed vehicle and/or the towing vehicle in the first and second directions after actuation of the brakes of the towing vehicle.

2. A method, as set forth in claim 1, wherein the step of detecting a braking event includes the steps of sensing operation of a brake pedal of the towing vehicle, the measured acceleration of the towed vehicle and/or the towing vehicle in the first and second directions being after operation of the brake pedal is sensed, but prior to actual actuation of the brakes.

3. A method, as set forth in claim 1, wherein the measured acceleration of the towed vehicle and/or the towing vehicle in the first and second directions is validated if the measured acceleration is within a limited range of the reference gravity vector.

4. A method, as set forth in claim 3, wherein the measured acceleration is a vector and the limited range is defined by a predetermined range of degrees.

5. A method, as set forth in claim 4, wherein the predetermined range has a predetermined minimum value and a predetermined maximum value, the method including the steps of:
incrementally decreasing the predetermined range and incrementing the reference vector in the direction of the measured acceleration of the towed vehicle and/or the towing vehicle, if the measured acceleration is validated; and
incrementally increasing the predetermined range, if the measured acceleration is not validated.

6. A method, as set forth in claim 1, wherein the reference gravity vector is established using one or a combination of one or more of the following:
(a) a calibration routine which establishes reference gravity vector while the towing vehicle and/or the towed vehicle are level and stationery;
(b) an averaging method which calculates a time weighted and/or event-weighted average acceleration during non-braking conditions; and,
(c) an averaging method which screens out events likely to be associated with heavy throttle conditions.

7. A method, as set forth in claim 1, wherein the conditions for validating the measured acceleration of the towed vehicle and/or the towing vehicle in the first and second directions become more stringent as a rate of validity increases.

8. A method, as set forth in claim 1, wherein the measured acceleration of the towed current actuation of the brakes is not validated if the time period between the current application of the brakes and a previous application of the brakes is less than a predetermined time period.

9. A method, as set forth in claim 1, wherein the surrogate data is a previous gravity vector used in a previous application of the brakes or the reference gravity vector.

10. A method for controlling the brakes of a towed vehicle, towed by a towing vehicle, in response to actuation of the brakes of the towing vehicle, comprising the steps of:
establishing a reference gravity vector representing acceleration of the towed vehicle and/or the towing vehicle due to gravity;
detecting a braking event and responsively establishing an effective gravity vector, wherein the effective gravity vector is:
(a) equal to a surrogate gravity vector if (i) the time period between the current braking event and a previous braking event is less than a predetermined time period and/or (ii) a measured acceleration of the towed vehicle and/or towing vehicle is outside a limited range of the reference gravity vector; or
(b) equal to the measured acceleration of the towed vehicle and/or towing vehicle, otherwise; and,
controlling the brakes of the towed vehicle as a function of the effective gravity vector and measured acceleration of the towed vehicle and/or the towing vehicle.

11. A system for controlling a brake mechanism of a towed vehicle towed by a towing vehicle, comprising:
an accelerometer device for measuring acceleration of one of the vehicles in a first direction and responsively establishing a first acceleration value and for measuring acceleration of the one of the vehicles in a second direction and responsively establishing a second acceleration value, the first and second directions being perpendicular; and,
a controller coupled to the accelerometer device for establishing a reference gravity vector representing acceleration of the towed vehicle and/or the towing vehicle due to gravity, for detecting a braking event of the towing vehicle and responsively validating a measured acceleration of the towed vehicle and/or the towing vehicle in first and second directions as a function of the reference gravity vector, and for establishing an effective gravity vector as a function of the measured acceleration of the towed vehicle and/or the towing vehicle in the first and second directions if validated and as a function of surrogate data if not validated and controlling the brakes of the towed vehicle as a function of the effective gravity vector and the measured acceleration of the towed vehicle and/or the towing vehicle in the first and second directions after detection of the braking event.

12. A system, as set forth in claim 11, wherein the controller, in detecting a braking event, senses operation of a brake pedal of the towing vehicle, and wherein the measured acceleration of the towed vehicle and/or the towing vehicle in the first and second directions being after operation the brake pedal, but prior to actual actuation of the brakes.

13. A system, as set forth in claim 11, wherein the measured acceleration of the towed vehicle and/or the towing vehicle in the first and second directions is validated if within a limited range of the reference gravity vector.

14. A system, as set forth in claim 13, wherein the predetermined range has a predetermined minimum value and a predetermined maximum value, the controller for incrementally decreasing the predetermined range and incrementing the reference vector in the direction of the measured acceleration of the towed vehicle and/or the towing vehicle, if the measured acceleration is validated and for incrementally decreasing the predetermined range, if the measured acceleration is not validated.

15. A system, as set forth in claim 11, wherein the controller establishes the reference gravity vector by using a calibration routine and/or an averaging method.

16. A system, as set forth in claim 11, wherein the controller establishes the reference gravity vector using one or a combination of one or more of the following:
(a) a calibration routine which establishes reference G vector while the towing vehicle and/or the towed vehicle are level and stationery;
(b) an averaging method which calculates a time weighted and/or event-weighted average acceleration during non-braking conditions; and,
(c) an averaging method which screens out events likely to be associated with heavy throttle conditions.

17. A system, as set forth in claim 11, wherein the conditions for validating the measured acceleration of the towed vehicle and/or the towing vehicle in the first and second directions just prior to actual application of the brakes become more stringent as a rate of validity increases.

18. A system, as set forth in claim 11, wherein the measured acceleration of the towed current actuation of the brakes is not validated if the time period between the current application of the brakes and a previous application of the brakes is less than a predetermined time period.

19. A system, as set forth in claim 11, wherein the surrogate data is a previous gravity vector used in a previous application of the brakes or the reference gravity vector.

20. A system for controlling the brakes of a towed vehicle, towed by a towing vehicle, in response to actuation of the brakes of the towing vehicle, comprising:
an accelerometer device for measuring acceleration of one of the vehicles in a first direction and responsively establishing a first acceleration value and for measuring acceleration of the one of the vehicles in a second direction and responsively establishing a second acceleration value, the first and second directions being perpendicular; and,
a controller coupled to the accelerometer device for detection a braking event of the towing vehicle and establishing an effective gravity vector, and for controlling the brakes of the towed vehicle as a function of the effective gravity vector and the measured acceleration of the towed vehicle and/or the towing vehicle in the first and second directions after actuation of the brakes of the towing vehicle, wherein the effective gravity vector is:
(a) equal to a surrogate gravity vector if (i) the time period between the current braking event and a previous braking event is less than a predetermined time period and/or (ii) the measured acceleration of the towed vehicle and/or towing vehicle is outside a limited range of the reference gravity vector; or
(b) equal to the measured acceleration of the towed vehicle and/or towing vehicle, otherwise.
